(19) United States
(12) Patent Application Publication
(10) Pub. No.: US 2025/0076799 A1
(43) Pub. Date: Mar. 6, 2025

(54) FIXING DEVICE AND IMAGE FORMING APPARATUS CAPABLE OF MAKING TEMPERATURE DISTRIBUTION UNIFORM WITH SIMPLE CONFIGURATION

(71) Applicant: KYOCERA Document Solutions Inc., Osaka (JP)

(72) Inventors: Rina Kikugawa, Osaka (JP); Ryohei Tokunaga, Osaka (JP); Akihiro Kondo, Osaka (JP); Yuta Kitabayashi, Osaka (JP); Hiroki Kawasaki, Osaka (JP); Shunsaku Fujii, Osaka (JP); Yuto Masaoka, Osaka (JP); Tomohiro Watatani, Osaka (JP)

(21) Appl. No.: 18/819,948

(22) Filed: Aug. 29, 2024

(30) Foreign Application Priority Data
Aug. 30, 2023 (JP) 2023-139899

(51) Int. Cl. G03G 15/20; G03G 15/00

(52) U.S. Cl. CPC G03G 15/2053; G03G 15/2064; G03G 15/5045; G03G 2215/2038

(57) ABSTRACT

A fixing device includes a heater, a holding member, and a pressure member. The heater heats a fixing belt. The holding member holds the heater such that the front surface of the heater is in contact with the inner peripheral surface of the fixing belt. The pressure member is pressed by the heater with the fixing belt interposed therebetween. The holding member includes a concave portion for accommodating the heater, a seating surface that is in contact with the back surface of the heater is formed in the concave portion, and the seating surface is formed such that an area of a contact surface with the heater in a circumferential direction of the fixing belt is narrower or wider at a location than at another location in a width direction that intersects the circumferential direction.

### INCORPORATION BY REFERENCE

This application is based upon and claims the benefit of priority from the corresponding Japanese Patent Application No. 2023-139899 filed on Aug. 30, 2023, the entire contents of which are incorporated herein by reference.

### BACKGROUND

The present disclosure relates to a fixing device that fixes a toner image onto a sheet and an image forming apparatus including the fixing device.

A sliding type fixing device includes an endless fixing belt which is heated by a heater and a pressure member which comes into contact with the fixing belt to form a pressure area, and the fixing belt and the pressure member rotate to fix a toner image onto a sheet conveyed to the pressure area. In such a fixing device, it is necessary to make the temperature distribution of the fixing belt uniform in order to eliminate uneven fixing.

In general, the heater is held by a holding member so as to be in contact with the inner peripheral surface of the fixing belt. In addition, the fixing device may be provided with a temperature sensor that measures the temperature of the heater. As described above, the heater is in contact with the holding member and the temperature sensor in addition to the fixing belt. Therefore, the heat generated from the heater is transmitted to members other than the fixing belt, making it difficult for the temperature of the fixing belt to rise at the locations where the heater is in contact with these members. In particular, if the contact locations exist locally in the width direction of the fixing belt, the temperature distribution of the fixing belt in the width direction may become non-uniform, and image defects may occur due to temperature unevenness.

A fixing device is known in which a highly thermal conductive member is disposed between a heater and a heat insulating support member that holds the heater. By disposing the highly thermal conductive member in this manner, even if there is variation in the temperature rise distribution of the heater, heat is conducted along the highly thermal conductive member and the temperature distribution is made uniform.

### SUMMARY

A fixing device of the present disclosure includes a fixing belt, a heater, a holding member, and a pressure member. The fixing belt is endless and rotatable. The heater heats the fixing belt. The holding member holds the heater such that the front surface of the heater is in contact with the inner peripheral surface of the fixing belt. The pressure member is pressed by the heater with the fixing belt interposed therebetween and forms, between the pressure member and the fixing belt, a pressure area for heating and pressing a sheet on which a toner image has been transferred. The holding member includes a concave portion for accommodating the heater, a seating surface that is in contact with the back surface of the heater is formed in the concave portion, and the seating surface is formed such that an area of a contact surface with the heater in a circumferential direction of the fixing belt is narrower or wider at a location than another location in a width direction that intersects the circumferential direction.

This Summary is provided to introduce a selection of concepts in a simplified form that are further described below in the Detailed Description with reference where appropriate to the accompanying drawings. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a front view schematically showing an internal configuration of an image forming apparatus according to an embodiment of the present disclosure.

FIG. 2 is a cross-sectional view schematically showing a fixing device according to an embodiment of the present disclosure.

FIG. 3 is a bottom view of a holding member of the fixing device according to an embodiment of the present disclosure.

FIG. 4A is a cross-sectional view taken along line I-I in FIG. 3.

FIG. 4B is a cross-sectional view taken along line II-II in FIG. 3.

FIG. 5 is a graph showing the relationship between the position of a fixing belt in the longitudinal direction and the temperature of the fixing belt in the fixing device according to an embodiment of the present disclosure.

FIG. 6 is a bottom view of a holding member of a conventional fixing device.

FIG. 7 is a graph showing the relationship between a contact area of the holding member and a heater and the temperature of the fixing belt in the fixing device according to an embodiment of the present disclosure.

### DETAILED DESCRIPTION

Hereinafter, an image forming apparatus and a fixing device according to the present disclosure will be described with reference to the drawings.

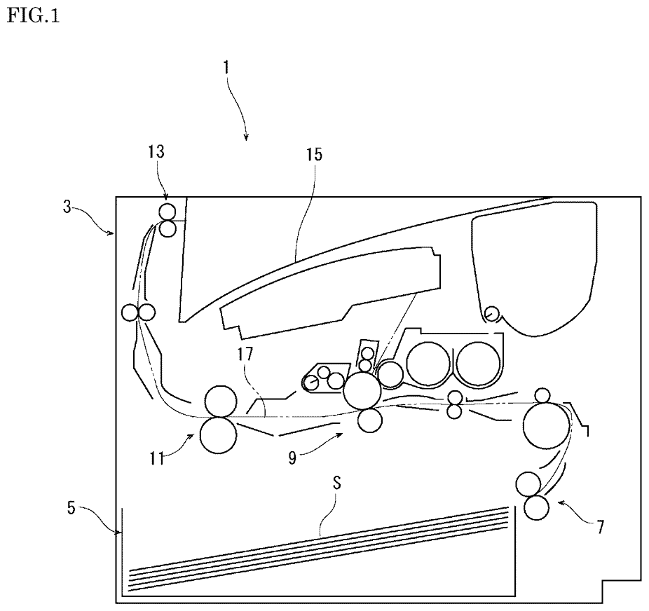

First, the general configuration of an image forming apparatus 1 will be described with reference to FIG. 1. FIG. 1 is a front view schematically showing an internal configuration of the image forming apparatus 1. Hereinafter, it is assumed that the near side in FIG. 1 on the paper is the front side of the image forming apparatus 1.

An apparatus main body 3 of the image forming apparatus 1 is provided with a sheet feed cassette 5 that stores a sheet S, a sheet feed device 7 that feeds the sheet S from the sheet feed cassette 5, an image forming portion 9 that forms a toner image on the sheet S using an electrophotographic method, a fixing device 11 that fixes the toner image onto the sheet S, a sheet discharge device 13 that discharges the sheet S, and a sheet discharge tray 15 on which the discharged sheet S is stacked. Further, in the apparatus main body 3, a conveying path 17 for the sheet S from the sheet feed device 7 to the sheet discharge device 13 through the image forming portion 9 and the fixing device 11 is formed.

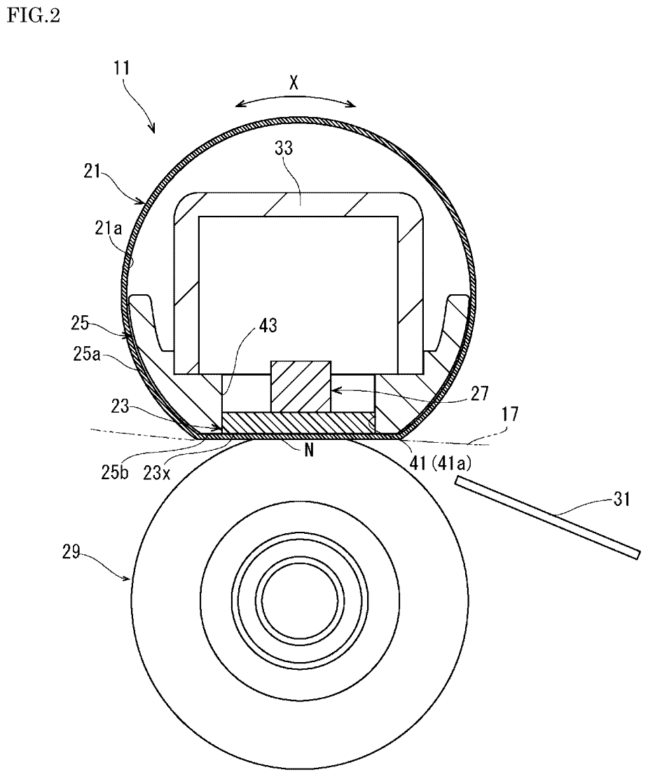

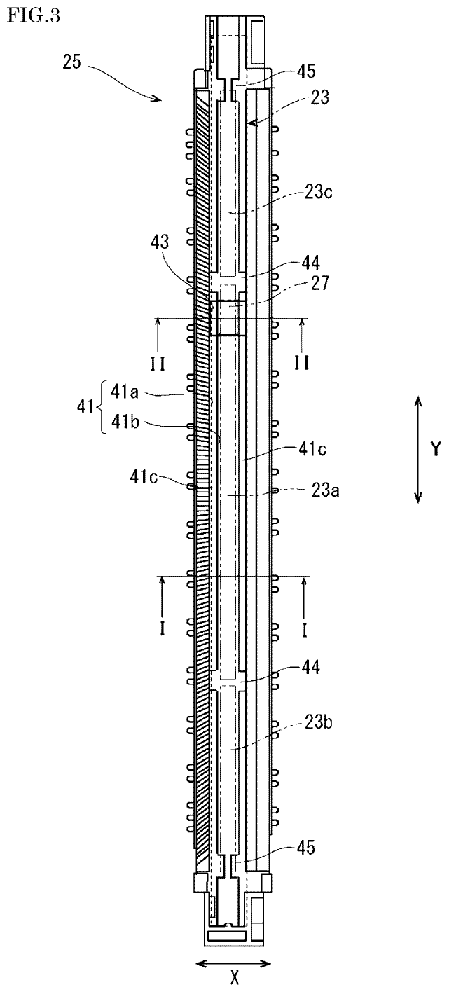

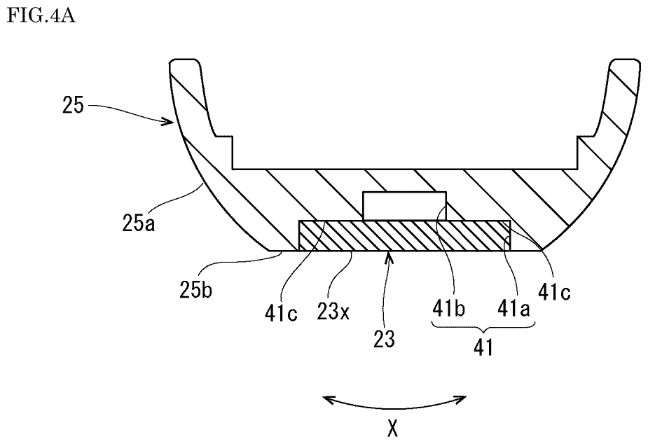

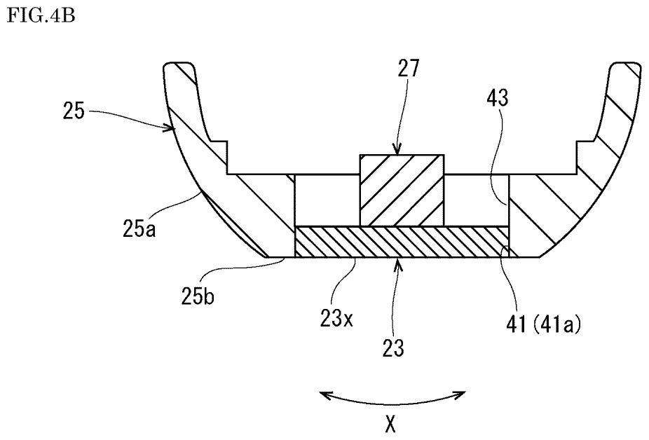

Next, the fixing device 11 will be described with reference to FIG. 2, FIG. 3, FIG. 4A, and FIG. 4B. FIG. 2 is a cross-sectional view of the fixing device 11, FIG. 3 is a bottom view of a holding member 25, and FIG. 4A and FIG. 4B are cross-sectional views of the holding member 25, a heater 23, and a temperature sensor 27. FIG. 4A is a cross-sectional view taken along line I-I in FIG. 3, and FIG. 4B is a cross-sectional view taken along line II-II in FIG. 3.

As shown in FIG. 2, the fixing device 11 includes a fixing belt 21, a heater 23 that heats the fixing belt 21, a holding member 25 that holds the heater 23, a temperature sensor 27 that detects the temperature of the fixing belt 21, a pressure roller 29 as a pressure member that forms a pressure area N between the fixing belt 21 and the pressure roller 29, and a guide 31 that guides the sheet S to the pressure area N.

The fixing belt 21 is an endless belt having a predetermined inner diameter and a width longer than the width of the sheet S. The fixing belt 21 is made of a flexible material, and includes a base material layer, an elastic layer provided on the outer peripheral surface of the base material layer, and a release layer provided on the outer peripheral surface of the elastic layer. The base material layer is made of a metal such as SUS or Ni. The elastic layer is made of silicon rubber or the like. The release layer is made of a PFA tube or the like. A sliding layer may be formed on the inner peripheral surface of the base material layer. The sliding layer is made of polyimide amide, PTFE, or the like.

Both ends of the fixing belt 21 are supported by end holders (not shown). Both end holders are rotatably supported by a fixing housing (not shown). A stay 33 extends through a hollow portion of the fixing belt 21. Both ends of the stay 33 are supported by the fixing housing.

The heater 23 is a flat plate-shaped member and has a width equivalent to the width of the fixing belt 21 (length along the width direction Y that intersects the circumferential direction X) and a predetermined length and thickness. The heater 23 has a laminated structure in which a substrate made of stainless steel or ceramic, an electrically insulating layer made of glass, a resistance heating element layer having an electrode, and a protective layer are stacked in this order from the back side to the front side. As shown in FIG. 3, the resistance heating layer is divided in the width direction Y into a central heating layer 23a and end heating layers 23b and 23c disposed on both sides of the central heating layer 23a in the width direction Y. A predetermined distance is provided between the central heating layer 23a and each of the end heating layers 23b and 23c in order to maintain insulation therebetween. The surface of the protective layer is flat and serves as a sliding surface 23x that is in contact with the inner peripheral surface 21a of the fixing belt 21. When the resistance heating element layer is energized through the electrode, the resistance heating element layer generates heat.

The holding member 25 is a substantially semi-cylindrical member and has a width equivalent to the width of the fixing belt 21 and a predetermined length along the circumferential direction X. The holding member 25 is made of, for example, a heat-resistant resin such as a liquid crystal polymer.

As shown in FIG. 2, the outer peripheral surface 25a of the holding member 25 is curved along an inner peripheral surface 21a of the fixing belt 21. The outer peripheral surface FIG. 4A of a top portion 25b of the holding member 25 is formed flat. A concave portion 41 for accommodating the heater 23 is formed in the top portion 25b along the width direction Y. As shown in FIGS. 3 and 4A, the concave portion 41 includes an outer concave portion 41a having a long length along the circumferential direction X and an inner concave portion 41b having a shorter length along the circumferential direction X than the outer concave portion 41a. A seating surface 41c parallel to the top portion 25b of the holding member 25 is formed on both sides of the inner concave portion 41b in the circumferential direction X.

As shown in FIG. 4A, the heater 23 is accommodated in the outer concave portion 41a. The sliding surface 23x of the heater 23 is flush with the outer peripheral surface of the top portion 25b of the holding member 25, and the back surface of the heater 23 is in contact with the seating surface 41c of the concave portion 41.

As shown in FIG. 3 and FIG. 4B, a rectangular through hole 43 is formed at one end of the holding member 25 in the width direction Y to penetrate the concave portion 41 (the outer concave portion 41a and the inner concave portion 41b) in the thickness direction.

The temperature sensor 27 is a thermistor, thermocut, or the like and, as shown in FIG. 2, it is supported by the stay 33 and disposed in the area where the central heating layer 23a and the end heating layer 23c are formed, and is in contact with the back surface of heater 23 through the through hole 43 of the holding member 25 (see also FIG. 3 and FIG. 4B). The length of the temperature sensor 27 along the circumferential direction X is shorter than the length of the through hole 43 along the circumferential direction X. Therefore, there are spaces on both sides of the temperature sensor 27 in the circumferential direction X, and the heater 23 and the holding member 25 are not in contact with each other. On the other hand, as shown in FIG. 4A, the heater 23 is in contact with the seating surface 41c of the concave portion 41 of the holding member 25 at locations other than the through hole 43. As described above, at a contact location between the temperature sensor 27 and the heater 23 (see FIG. 4B), the area of the contact surface between the holding member 25 and the heater 23 is narrower than that at locations other than the contact location (see FIG. 4A).

Referring again to FIG. 2, the pressure roller 29 includes a core, an elastic layer provided on the outer peripheral surface of the core, and a release layer provided on the outer peripheral surface of the elastic layer. The elastic layer is made of silicon rubber or the like. The release layer is made of a PFA tube or the like.

The pressure roller 29 is supported so as to be pressed against the heater 23 from below the fixing belt 21. Thus, a pressure area N is formed between the fixing belt 21 and the pressure roller 29. The pressure roller 29 is driven by a motor (not shown) and rotates in the counterclockwise direction in FIG. 2. When the pressure roller 29 is driven and rotated by the motor, the fixing belt 21 is driven and rotated in the clockwise direction in FIG. 2, which is opposite to the rotation direction of the pressure roller 29. Accordingly, the sheet S conveyed along the conveying path 17 passes through the pressure area N.

A guide 31 is disposed upstream of the pressure area N in the conveying direction of the sheet S, and guides the sheet S conveyed along the conveying path 17 to the pressure area N.

A fixing operation of the fixing device 11 having the above-described configuration will be described. First, the pressure roller 29 is driven and rotated by the motor, and the fixing belt 21 is driven by the pressure roller 29 to rotate in a direction (clockwise direction in FIG. 2) opposite to the rotation direction of the pressure roller 29. At the same time, the heater 23 is driven to heat the fixing belt 21. The temperature of the heater 23 is detected by the temperature sensor 27. The heater 23 is heated until the detected temperature reaches a predetermined control temperature (e.g., 160° C.) to heat the fixing belt 21. After the fixing belt 21 is heated in this manner, the sheet S on which the toner image has been transferred is guided by the guide 31 and conveyed to the pressure area N. When the sheet S passes through the pressure area N, the sheet S is heated by the fixing belt 21 and pressed by the pressure roller 29 and the fixing belt 21, so that the toner image is fixed onto the sheet S. The sheet S on which the toner image has been fixed is conveyed from the pressure area N along the conveying path 17.

The heat generated by the heater 23 is transferred to the fixing belt 21 to heat the fixing belt 21, but also transferred to the holding member 25. Further, since the temperature sensor 27 is in contact with the back surface of the heater 23 as described above, the heat is also transferred to the temperature sensor 27. Since the temperature sensor 27 is disposed at one end in the width direction Y, the amount of heat transferred from the heater 23 to portions other than the fixing belt 21 is locally increased at the contact location between the temperature sensor 27 and the heater 23. This makes it difficult for the temperature of the fixing belt 21 to rise at the contact location between the temperature sensor 27 and the heater 23, and the temperature distribution of the fixing belt 21 in the width direction Y becomes non-uniform.

To deal with this, a fixing device is known in which a highly thermal conductive member is disposed between the heater 23 and a heat insulating support member that holds the heater. By disposing the highly thermal conductive member in this manner, even if there is variation in the temperature rise distribution of the heater, heat is conducted along the highly thermal conductive member and the temperature distribution is made uniform.

However, in the above-described fixing device, there is a problem that the highly thermal conductive member causes an increase in the number of parts, the cost, and the number of manufacturing steps.

On the other hand, the fixing device 11 according to the embodiment of the present disclosure can make the temperature distribution uniform with a simple configuration.

Specifically, as described above, according to the fixing device 11 of the present disclosure, the heater 23 and the holding member 25 (the seating surface 41c) are not in contact with each other at the contact location (see FIG. 4B) between the temperature sensor 27 and the heater 23 where the temperature of the fixing belt 21 does not easily rise. That is, the amount of heat transferred from the heater 23 to a member (the holding member 25) other than the fixing belt 21 at the contact location between the temperature sensor 27 and the heater 23 can be reduced. Accordingly, the temperature distribution of the fixing belt 21 in the width direction Y can be made uniform more easily.

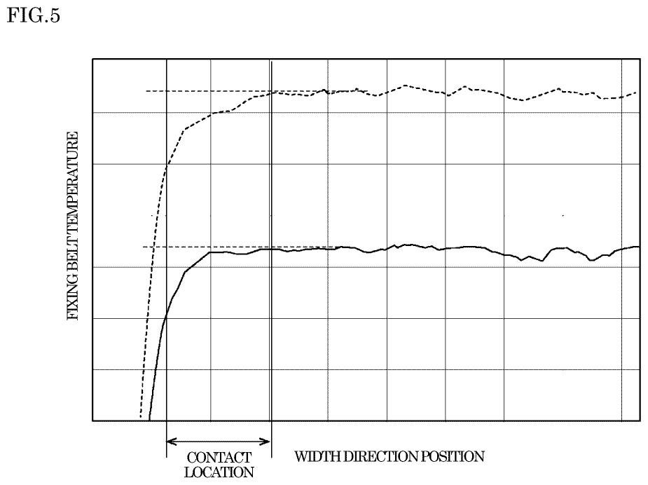

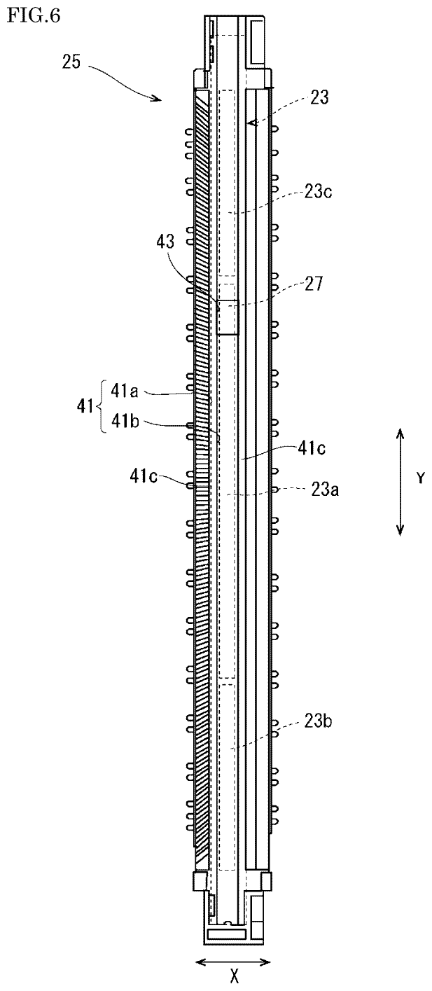

Referring to FIG. 5, a temperature measurement result of the fixing belt 21 in an example will be described. As the example, the fixing device 11 described in the above embodiment is shown. As a comparative example, a conventional fixing device (see FIG. 6) is shown in which the length of the through hole 43 along the circumferential direction X is the same as the length of the inner concave portion 41b of the concave portion 41, and the back surface of the heater 23 is in contact with the seating surface 41c of the concave portion 41 of the holding member 25 at the contact location between the temperature sensor 27 and the heater 23.

FIG. 5 is a graph showing the relationship between the position of the fixing belt 21 in the width direction Y and the temperature of the fixing belt 21. The horizontal axis of the graph indicates the position of the fixing belt 21 in the width direction Y, and the vertical axis indicates the temperature of the fixing belt 21. The solid line in the graph indicates the example, and the chain line indicates the comparative example. The vertical axis is for illustration of the difference between the example and the comparative example, and does not indicate the actual temperature.

As can be seen from the graph, at the contact location between the heater 23 and the temperature sensor 27, the area between the baseline of the temperature (indicated by the chain line) and the measured temperature is smaller in the example than in the comparative example. Namely, the degree of decrease in temperature at the contact location is smaller in the example. In other words, the temperature of the fixing belt 21 more easily rises.

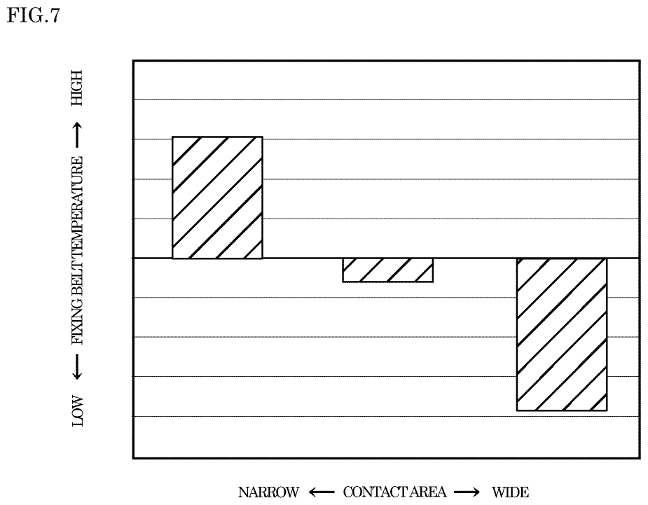

Next, the relationship between the contact area between the heater 23 and the holding member 25 and the temperature of the fixing belt 21 will be described with reference to FIG. 7. FIG. 7 is a graph showing the relationship between the contact area of the heater 23 and the holding member 25 and the temperature of the fixing belt 21. The horizontal axis of the graph indicates the contact area, and the vertical axis indicates the temperature of the fixing belt 21.

As can be seen from the graph, the narrower the contact area, the easier it is for the temperature of the fixing belt 21 to rise, and the wider the contact area, the harder it is for the temperature of the fixing belt 21 to rise. That is, the narrower the contact area, the easier it is for the temperature of the fixing belt 21 to rise.

As described above, the contact location between the temperature sensor 27 and the heater 23 is a location where the temperature of the fixing belt 21 does not easily rise. In other words, the contact location between the temperature sensor 27 and the heater 23 is a location where the temperature of the fixing belt 21 is desired to be raised. By narrowing the contact area between the holding member 25 and the heater 23 at such a location, the amount of heat transferred from the heater 23 to a member (the holding member 25) other than the fixing belt 21 can be reduced. Conversely, at the location where the temperature of the fixing belt 21 is not desired to be raised, the amount of heat transferred from the heater 23 to a member other than the fixing belt 21 can be increased by increasing the contact area between the holding member 25 and the heater 23.

In addition, as described above, there is no resistance heating element between the central heating layer 23a and each of the end heating layers 23b and 23c of the resistance heating layer of the heater 23, so that the amount of heat transferred to the fixing belt 21 between the adjacent heating layers 23a, 23b and 23c is reduced. Therefore, as shown in FIG. 3, regions 44 where the contact area between the heater 23 and the holding member 25 is narrowed is formed between adjacent heating layers 23a, 23b, and 23c. In the narrow contact area regions 44, the seating surface 41c is cut out by a predetermined width in the width direction Y and is not in contact with the back surface of the heater 23.

Alternatively, in non-sheet passing areas (both ends of the resistance heating layer of the heater 23 in the width direction Y), the temperature is not transferred from the fixing belt 21 to the sheet S, so that the temperature of the fixing belt 21 rises. Accordingly, as shown in FIG. 3, wide contact width regions 45 having a large contact area between the holding member 25 and the heater 23 are formed in the non-sheet passing areas. In the wide contact width regions 45, the facing seating surfaces 41c extend toward each other, so that the area of the seating surface 41c in contact with the back surface of the heater 23 is wide. Accordingly, the amount of heat transferred from the heater 23 to the holding member 25 is increased, so that the temperature rise in the non-sheet passing area can be suppressed.

As described above, the temperature of the fixing belt 21 can be controlled by the contact area between the heater 23 and the holding member 25. In the above embodiment, the seating surface 41c of the concave portion 41 of the holding member 25 and the back surface of the heater 23 are not in contact with each other at the contact location between the temperature sensor 27 and the heater 23, but the width of the seating surface 41c may be narrowed to narrow the contact area with the heater 23. In addition, in the above-described embodiment, the case where the contact member that is in contact with the back surface of the heater 23 is the temperature sensor 27 has been described, but the contact member may be a stay, a connector, or the like other than the temperature sensor 27.

Further, the above description of the embodiment of the present disclosure is intended to describe a preferred embodiment of the present disclosure, and therefore, various technically preferable limitations may have been added, but the technical scope of the present disclosure is not limited to these aspects unless there is a description that particularly limits the present disclosure.

It is to be understood that the embodiments herein are illustrative and not restrictive, since the scope of the disclosure is defined by the appended claims rather than by the description preceding them, and all changes that fall within metes and bounds of the claims, or equivalence of such metes and bounds thereof are therefore intended to be embraced by the claims.

1. A fixing device comprising:
a rotatable endless fixing belt;
a heater configured to heat the fixing belt;
a holding member configured to hold the heater such that a front surface of the heater is in contact with an inner peripheral surface of the fixing belt; and
a pressure member configured to be pressed by the heater with the fixing belt interposed therebetween to form, between the pressure member and the fixing belt, a pressure area for heating and pressing a sheet on which a toner image has been transferred, wherein
the holding member includes a concave portion for accommodating the heater, and a seating surface that is in contact with a back surface of the heater is formed in the concave portion, and
the seating surface is formed such that an area of a contact surface with the heater in a circumferential direction of the fixing belt is narrower or wider at a location than at another location in a width direction that intersects the circumferential direction.

2. The fixing device according to claim 1, further comprising a contact member that is in contact with the back surface of the heater, wherein
the holding member is formed such that an area of a contact surface between the seating surface and the heater is smaller at a contact location between the contact member and the heater than at a location other than the contact location.

3. The fixing device according to claim 2, wherein
the contact member is a temperature sensor configured to detect a temperature of the heater.

4. The fixing device according to claim 1, wherein
in the heater, a plurality of heating layers divided along the width direction are formed, and a predetermined gap is formed at a boundary between adjacent heating layers of the heating layers, and
the holding member is formed such that an area of a contact surface between the seating surface and the heater is smaller at the gap than at a location other than the gap.

5. The fixing device according to claim 1, wherein
a heating layer extending in the width direction is formed in the heater, and
the holding member is formed such that an area of a contact surface between the seating surface and the heater is wider in a neighborhood of both ends of the heating layer in the width direction than at a location other than the neighborhood of the both ends.

6. An image forming apparatus comprising:
an image forming portion configured to form a toner image on a sheet; and
the fixing device according to claim 1 configured to fix the toner image onto the sheet.
